(19) United States
(12) Patent Application Publication
(10) Pub. No.: US 2006/0244897 A1
(43) Pub. Date: Nov. 2, 2006

(54) Modular eyewear

(76) Inventor: Siegmar W. Guenther, Conroe, TX (US)

Correspondence Address: SONNABENDLAW, 600 PROSPECT AVE, BROOKLYN, NY, 11215, US

(21) Appl. No.: 11/115,895

(22) Filed: Apr. 27, 2005

(51) Int. Cl. G02C 1/00

(52) U.S. Cl. 351/43

(57) ABSTRACT

Modular eyewear, which may be referred to generally as goggles or glasses without being limited to such uses, generally consisting of three primary elements: a frame, one or more lens modules, and one or more temple pieces. All three primary elements are detachable from one another and interchangeable with like components

### BACKGROUND OF THE INVENTION

1. Field of the Invention

The present invention relates generally to the field of eyewear, and more specifically to the field of modular eyewear.

2. Background of the Related Art

It has long been the aim of designers of goggles, eyeglasses and other eyewear to provide a modular system that permits users to interchange lenses, temple pieces and/or various padding members. A review of the prior art reveals numerous attempts to provide such a system.

One example of an attempt to provide a modular eyewear system is U.S. Pat. No. 4,405,212, entitled “Spectacle Frame and Conversion Accessories Therefor,” which discloses a spectacle frame having removable temple pieces. The removable temples pieces may be attached to a frame (which includes lenses) by means of threaded pins, thereby forming a hinge about the axis of the threaded pins. This assembly provides inferior stress-strain properties, it is believed, and also has the added disadvantage of requiring a separate element (i.e., the threaded pins) to operatively join the temple pieces to the frame, thus increasing the chance that users may lose these pieces, rendering the eyewear inoperable.

Another example of an attempt to provide a suitable modular eyewear system is U.S. Pat. No. 5,189,447, entitled “Integrated Field Eyewear System.” This reference discloses a system including replaceable lenses, temple pieces, and the like. First, the reference discloses a replaceable lens system in which lens elements, consisting only of lenses and not of any frame or the like, are attached to a bridge element. This structure may optionally be attached to the rear portion of a goggle frame to provide goggle-like protection. Second, this reference discloses detachable temple pieces that directly mount to the aforementioned lenses. The disclosed device has several disadvantages, among them the absence of a frame to receive the interchangeable lens elements and thereby give the structure added rigidity. Likewise, the absence of a frame to receive the lens elements leaves the lenses largely unprotected and vulnerable to chipping and breaking by contacting foreign objects. Another disadvantage is the direct lens-to-temple piece connection, which permits the transmission of forces such as torsional and compressive forces from the temple piece directly to the lens element.

Next, U.S. Pat. No. 5,191,364, entitled “Protective Eyewear for Use in Sports and the Like,” discloses protective eyewear that includes adjustable/removable earpieces. The earpieces slide into a channel in a temple piece, which in turn is hinged to a frame member. This configuration has the disadvantages of being insufficiently rigid along the length of the temple/ear piece assembly, it is believed.

U.S. Pat. No. 5,682,621, entitled “Sports Safety Glasses,” discloses an eyewear system having interchangeable lenses. The disclosed device consists essentially of three components: a front outer frame, lenses, and rear inner frames with integral foam cushions. In operation, the lenses are sandwiched between the front outer frame and a rear inner frame, which snaps into the front outer frame in the rear. This configuration has the significant flaw of requiring separate lenses and rear inner frames, which may lead to damage or loss of the lenses, for example, if the lenses are dropped upon removing the rear inner frame from the front outer frame. Furthermore, the cushions are permanently affixed to and integral with the rear inner frames, thereby prohibiting a user from wearing the eyewear without foam cushioning.

Another reference which discloses removable lenses is U.S. Pat. No. 6,036,312, entitled “Protective Eyeglass Assembly Having a Unitary, Decentered Lens Piece.” This reference discloses a frame member with permanently affixed, hinged temple pieces and a lens assembly comprising two lenses mounted in a sub-frame with center nose bridge portion. The lens assembly snaps into the frame element via a t-shaped pin formed in each temple piece that mates with a complementary slot in the lens assembly. This arrangement has the disadvantages of being overly complex and cumbersome in the unitary construction of the lens/sub-frame assembly.

U.S. Pat. No. 5,711,035, entitled “Sports Safety Glasses,” discloses protective eyewear including removable temple pieces. The temple pieces have a male tab member which is operatively accepted into a slot in a partial temple piece attached to a frame member via a hinge. This arrangement has all the disadvantages associated with partial, hinged temple piece permanently attached to a frame member, including apparent rigidity issues and the like.

Yet another example of a modular protective eyewear system is the Bikereyes Helly Eagle brand eyewear system. This product includes a frame element which accepts lens modules for operative mounting therein. The lens modules are maintained in the frame element via tabs integrally formed with in the frame element that mate with corresponding slots in the lens modules when the lens modules are placed into the frame element. The product also includes removable temple pieces which operatively couple to a partial temple piece permanently attached to the frame element by a hinge. The lense modules have cushions permanently affixed thereto. In addition to all the disadvantageous previously discussed for the various product elements, this product has the added disadvantage of requiring significant deformation of the frame element for the insertion and removal of the tabs into the slots of the lens modules upon insertion and removal for the lens modules into and out of the frame element. Over time, this deformation is believed to weaken the frame element, eventually leading to failure of the plastic. Furthermore, the tabs may be prone to breaking, thereby rendering the frame element unusable.

With these considerations in mind, it is desirable to have a modular eyewear assembly which provides certain benefits of the prior art without the associated disadvantages discussed.

### SUMMARY OF THE INVENTION

The subject invention is directed to new and useful modular eyewear.

A preferred embodiment of the present invention consists of eyewear having a frame having at least one temple end, the frame defining at least one aperture and/or one cavity therein. The temple end may define an opening into one of the cavities.

The embodiment further or alternatively may include at least one lens module, the lens module having a front portion and rear portion, a lens element, a flange with a front and a back, and a projection, whereby the lens module may be operatively inserted into the aperture of the frame and extend therethrough such that the front of the flange operatively contacts a portion of the frame about the aperture. In these embodiments, the lens module may include a channel formed therein for accepting a portion of the frame therein to help maintain the lens module in the aperture. The projection of the lens module may include at least one tab formed thereon and the channel may be formed between the tab and the flange.

Additionally or alternatively, embodiments may include a temple piece having a frame end, the frame end terminating in a tab assembly having a tab, the tab being operatively acceptable into one of the cavities in the frame, through the opening in the temple end, for operatively attaching the temple piece to the frame. The tab assembly may articulate relative to the temple piece. Additionally, the tab assembly may include a latch and the frame may define a second opening into the cavity, the latch being operatively accepted into the second opening upon insertion of the tab into the cavity, thereby helping to maintain the temple piece operatively with the frame.

Embodiments of the present invention may also include a padding member removably attachable to the rear portion of the lens module. One or more tabs may be included on the padding member and/or the rear portion of the lens module, and one or more slots may be included in the other of the padding member and/or rear portion of the lens module corresponding to the aforementioned tabs, such that the padding member may be attached to the lens module by insertion of the tabs into corresponding ones of the slots. The padding member may have slits formed therein.

These and other aspects of the subject invention will become more readily apparent to those having ordinary skill in the art from the following detailed description of the invention taken in conjunction with the drawings described herein.

### BRIEF DESCRIPTION OF THE DRAWINGS

So that those having ordinary skill in the art to which the subject invention pertains will more readily understand how to make and use the subject invention, preferred embodiments thereof will be described in detail herein with reference to the drawings.

FIG. 1 is a side view of a preferred embodiment of the present invention.

FIG. 2A is a partial front view of a frame, including a lens module operatively inserted therein, of a preferred embodiment of the present invention.

FIG. 2B is a partial rear view of a frame, without a lens module, of a preferred embodiment of the present invention.

FIG. 3 is a top view of a lens module with pad element of a preferred embodiment of the present invention.

FIG. 4 is a front view of a lens module of a preferred embodiment of the present invention.

FIG. 5 is a plan view of a lens module and pad element of a preferred embodiment of the present invention.

FIG. 6 is a top view of various components of a preferred embodiment of the present invention in a disassembled state.

FIG. 7 is a partial detail view of a portion of a preferred embodiment of the present invention.

FIG. 8 is a top view of a temple element of a preferred embodiment of the present invention.

FIG. 9 is a side view of a temple element of a preferred embodiment of the present invention.

FIG. 10 is a reverse side view of a temple element of a preferred embodiment of the present invention.

FIG. 11 is a top view of various components of a preferred embodiment of the present invention in a partially disassembled state and partially assembled.

### DETAILED DESCRIPTION OF THE PREFERRED EMBODIMENTS

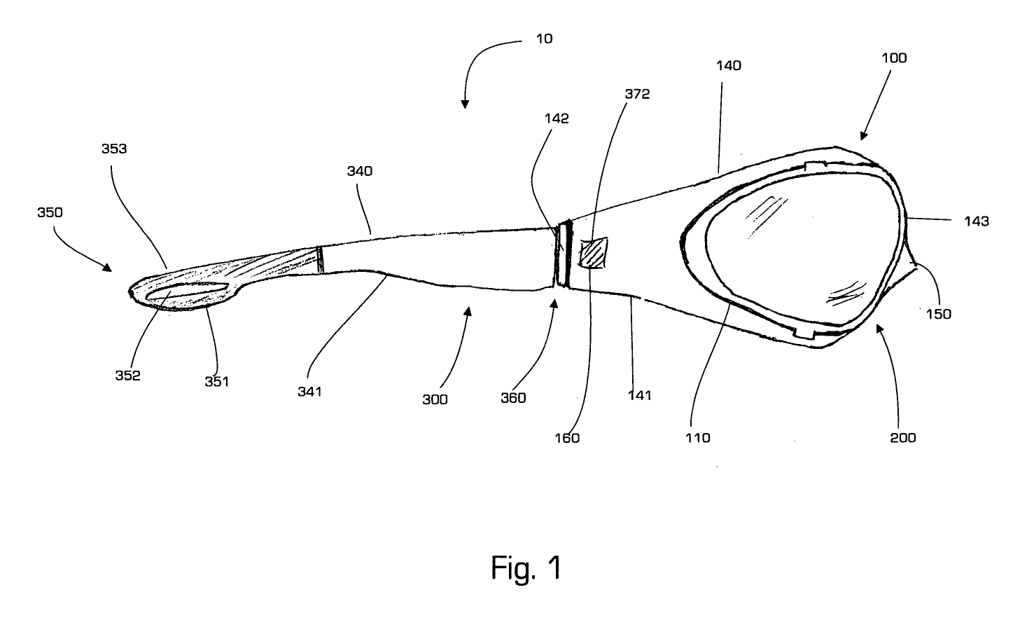

Referring now in detail to the drawings wherein like reference numerals identify similar structural features of the several embodiments of the subject invention, there is illustrated in FIG. 1 a side view of the modular eyewear of the present invention in a fully assembled arrangement. The modular eyewear 10, which may be referred to generally as goggles or glasses without being limited to such uses, generally consists of three primary elements: frame 100, lens module 200, and temple piece 300. All three primary elements are detachable from one another and interchangeable with like components, as will presently be described. These components may be made principally of plastic or other synthetic materials by molding, blow molding or the like. Other materials may be used without departing from the present invention, provided such materials provide sufficient elasticity for attachment and detachment of components as will be described.

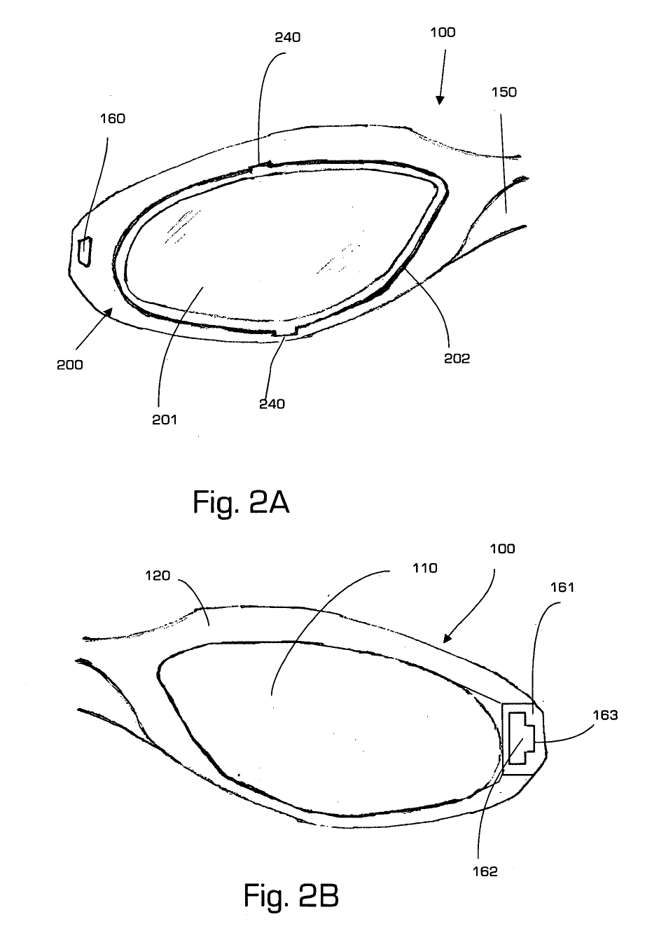

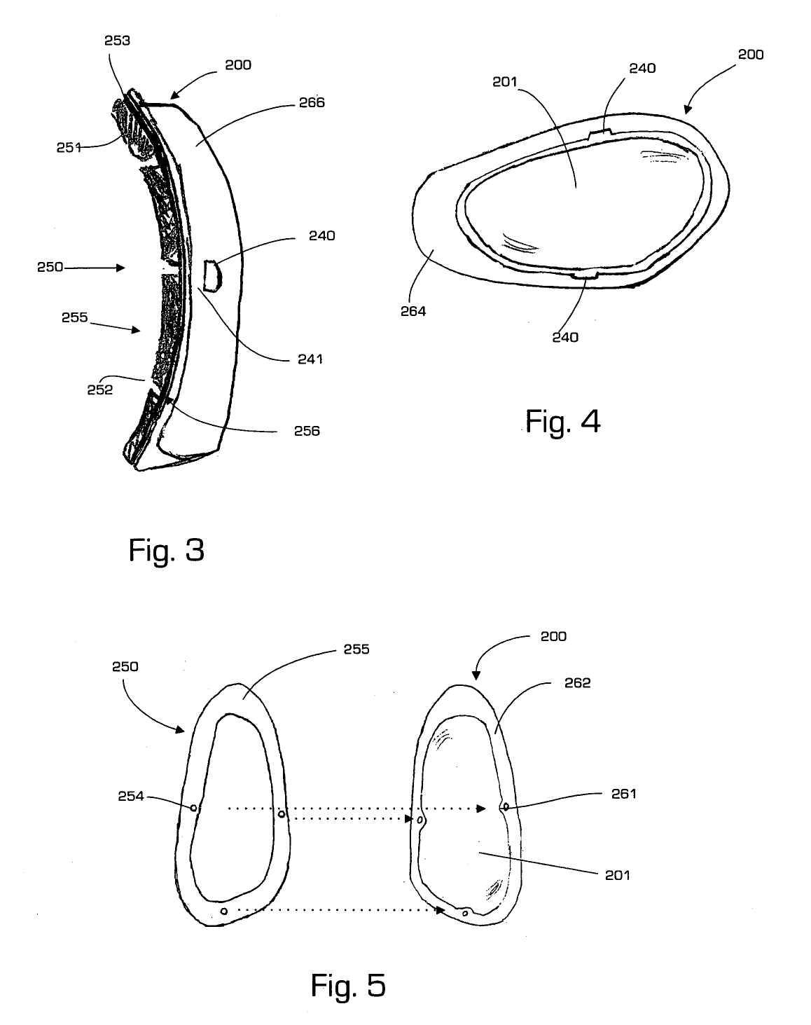

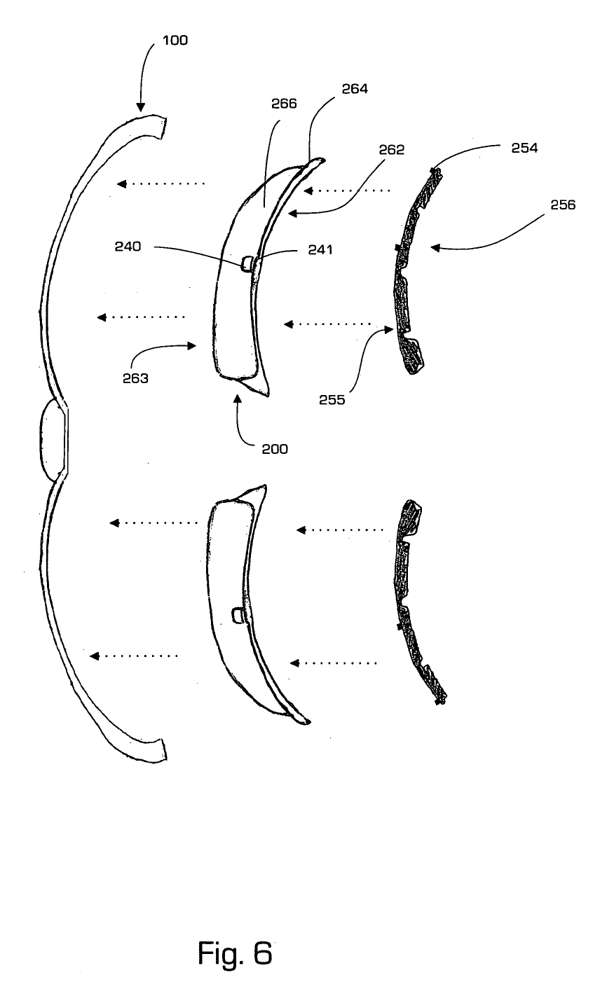

First, lens module 200 is detachable from frame 100. Lens module 200 may be operatively attached to frame 100 by being inserted into aperture 110, shown in FIGS. 2A and 2B, which is integrally formed in frame 100 and corresponds in shape to lens module 200. Lens module 200, shown in greater detail in FIGS. 3 and 4, includes flange 264 and projection 266. In operation, lens module 200 is inserted into aperture 110 of frame 100 so that projection 266 extends through aperture 110 and flange 264 abuts rear surface 120 of frame 100. In certain embodiments, the size of the flange may be minimized, effectively reducing the flange/tab subsystem to a groove-like configuration. Likewise, the flange need not be formed about the entire periphery of the lens module, and the flange/tab subsystem may be effectively reduced to a tab/tab subsystem or the like.

During insertion, tabs 240 make contact with frame 100 at locations about the periphery of aperture 110. Tabs 240 elastically deform frame 100, thereby permitting tabs 240 to pass through aperture 110, after which the portions of frame 100 that are coextensive with tabs 240 are maintained in channel 241 formed between each of tabs 240 and flange 264. In this manner, lens module 200 is operatively maintained in frame 100.

Alternatively or additionally, lens module 200 may include one or more grooves formed about its periphery, such grooves effectivedly creating a channel which may accept all or portions of frame 100 substantially as described above in connection with tabs 240.

Lens module 200 includes a lens 201, which may be a prescription lens, protective lens, sun-shielding lens, contrast increasing lens or the like, or any combination thereof. Lens 201 may be maintained in lens module 200 by means of a groove formed in lens module 200 (not shown), by adhesive, or by any other means known in the field of eyeglass and goggle making or later discovered in such fields.

By providing lens modules with differing lenses, users may select lens modules to satisfy particular and changing needs. For example, a clear lens, used for protective purposes, may be changed for a tinted lens as dictated by ambient light conditions. By way of further example, lens modules having purple tinted lenses may be exchanged for lens modules having yellow tinted lenses, thereby permitting the user to change the appearance of the eyewear. Likewise, frames may be of different shapes, sizes and colors/patterns, thereby permitting a user to change eyeglass styles—without the need to purchase different lenses—by removing lens modules from one frame and placing them in a different frame.

Lens module 200 may include padding element 250, which may be removably affixed thereto. In one embodiment of the present invention, padding element 250 includes a front portion 255 and a rear portion 256 formed from base portion 253. Pads 251 may be integrally formed in rear portion 256 to rest against a user's face in normal wear, thereby provide padding for the user. Pads 251 may be separated from one another by means of slits 252, thereby providing ventilation to the portion of the user's face located behind the lens module (i.e., the area of the user's face about the eyes). Alternatively, pads 251 may be continuous, thereby forming a seal about the user's face. In this alternative embodiment, the modular eyewear of the instant invention may be used as diving or swimming goggles, provided that all seals related to the coupling of the lens module to the frames are of sufficiently close tolerances and/or properly sealed so as to be water tight. Similarly, in such use, the seal formed between the padding element 250 and the user's face must be secure and water tight.

As shown in FIG. 5, padding element 250 may include one or more tabs 254 on front portion 255 which correspond to slots 261 located in rear portion 262 of lens module 200. Tabs 254 may be inserted into slots 261 so as to maintain padding element 250 in operative contact with lens module 200. The tabs and slots may be wholly or partially reversed, that is, tabs and slots may be placed on the padding element or on the lens module or both, without departing from the present invention.

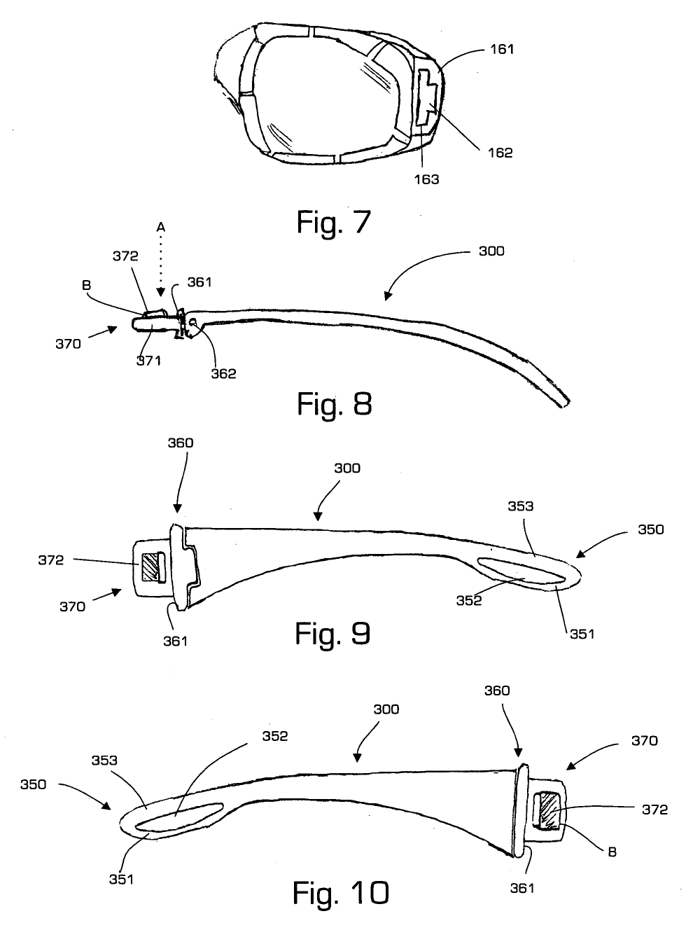

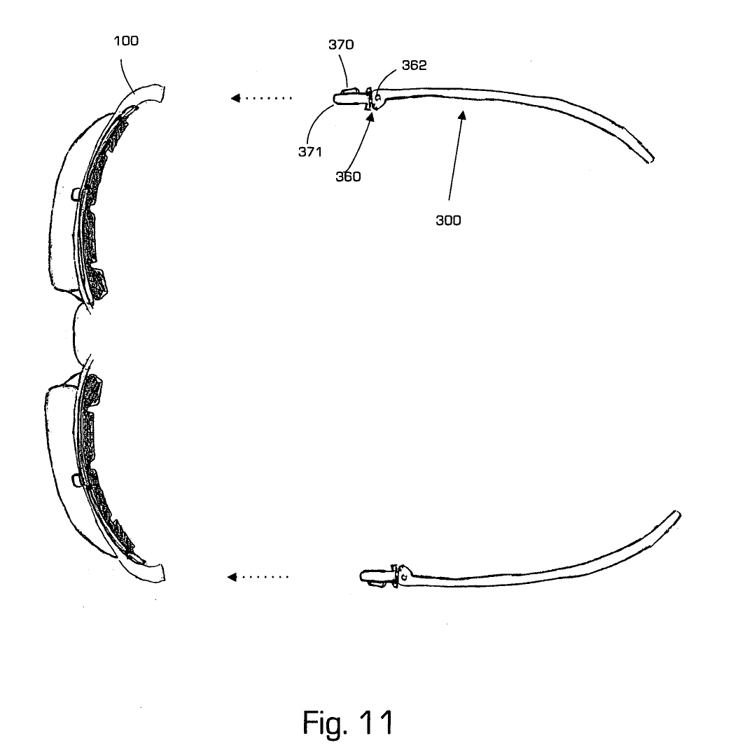

Next, removable temple piece 300 is shown in pertinent detail in FIGS. 7 through 11, as well as FIG. 1. Temple piece 300 operatively attaches to frame 100 by means of hinged tab assembly 370 formed in the frame end 360 of temple piece 300. Hinged tab assembly 370 includes tab 371 and latch 372, and is hinged about pin 362, which is preferably permanently inserted in the hinged tab assembly. While a rigid temple piece is illustrated, other temple pieces, such as straps and the like, may be used, provided they help maintain the eyewear on a user's face.

Tab 371 and latch 372 are shaped to correspond to cavity 162 formed integrally in frame 100 at one of the frame's temple end (i.e., an end to which a temple piece attaches). Latch 372 is affixed to or formed integrally with tab 371 in such a way so as to permit latch 372 to be elastically deformed downward in the direction indicated in the figure by arrow A. This may be accomplished by attaching latch 372 to tab 371 at side B without constraining it on any other side. In operation, latch 372 is deformed downward and tab 371 is inserted into cavity 162 through opening 163 formed in the end of frame 100. As will be readily understood, frame 100 includes two similarly configured ends corresponding to each of two temple pieces and associated ears of the wearer of the eyewear.

In its fully inserted position, flange 361 abuts face (i.e., surface) 161, thereby providing resistance against rotational forces applied along temple piece 300. Similarly, axial components of force transmitted along temple piece 300 may be absorbed by face 161, and sheering forces across tab 371 may be effectively absorbed by a substantial portion of frame 100, thereby minimizing the chance of sheering failure of temple piece 300 at tab 371. Also in this fully inserted position, latch 372 securely mates with opening 160 formed in frame 100 as illustrated in FIG. 1, thereby securing temple piece 300 to frame 100. To remove temple piece 300 from frame 100, latch 372 is again pushed downward, away from opening 160, while temple piece 300 is pulled axially away from cavity 162.

Temple piece 300 further includes ear portion 350, which includes rigid portion 353 and flexible portion 351 attached thereto. Rigid portion 353 and flexible portion 352 define a space 352 therebetween such that flexible portion 351 may be elastically deformed upwards into space 352 towards rigid portion 353. In this manner, the ear portion may be more securely and comfortably positioned behind a user's ear. The entire ear portion 350 may be constructed integrally with the temple piece 300, or may be affixed thereto. Ear portion 350 may be made of any material or combination of materials that have suitably soft and elastically deformable characteristics for flexible portion 351 and sufficiently rigid characteristics for rigid portion 353. These materials may include, among others, synthetic and natural rubbers, plastics, metals and metal alloys, and the like.

While particular embodiments of the present invention have been shown and described, it will be apparent to those skilled in the pertinent art that changes and modifications may be made without departing from the invention in its broader aspects.

What is claimed is:

1. Eyewear comprising:
a frame, said frame defining at least one aperture therein; and
at least one lens module, said lens module having a front portion and rear portion, a lens element, a flange with a front and a back, and a projection;
whereby said lens module may be operatively inserted into said aperture of said frame and extend therethrough such that said front of said flange operatively contacts a portion of said frame about said aperture.

2. The eyewear of claim 1 wherein said lens module includes a channel formed therein for accepting a portion of said frame therein to help maintain said lens module in said aperture.

3. The eyewear of claim 2 wherein said projection of said lens module includes at least one tab formed thereon and said channel is formed between said tab and said flange.

4. The eyewear of claim 1 further comprising a padding member removably attachable to said rear portion of said lens module.

5. The eyewear of claim 4 further comprising one or more tabs on said padding member and/or said rear portion of said lens module, one or more slots in the other of said padding member and/or rear portion of said lens module corresponding to said tabs, wherein said padding member may be attached to said lens module by insertion of said tabs into corresponding ones of said slots.

6. The eyewear of claim 4 further comprising slits in said padding member.

7. The eyewear of claim 4 wherein said lens module includes a channel formed therein for accepting a portion of said frame therein to help maintain said lens module in said aperture.

8. The eyewear of claim 7 wherein said projection of said lens module includes at least one tab formed thereon and said channel is formed between said tab and said flange.

9. Eyewear comprising:
a frame defining at least one cavity therein, said frame having at least one temple end, said temple end defining an opening into one of said cavities;
a temple piece having a frame end, said frame end terminating in a tab assembly having a tab, said tab being operatively acceptable into one of said cavities in said frame, through said opening therein, for operatively attaching said temple piece to said frame.

10. The eyewear of claim 9 wherein said tab assembly articulates relative to said temple piece.

11. The eyewear of claim 9 wherein said tab assembly includes a latch and said frame defines a second opening into said cavity, said latch being operatively accepted into said second opening upon insertion of said tab into said cavity, thereby helping to maintain said temple piece operatively with said frame.

12. The eyewear of claim 11 wherein said tab assembly articulates relative to said temple piece.

13. The eyewear of claim 9 wherein said tab assembly includes a flange, said flange operatively contacting at least a portion of said temple end of said frame upon insertion of said tab into said cavity.

14. The eyewear of claim 13 wherein said tab assembly articulates relative to said temple piece.

15. The eyewear of claim 14 wherein said tab assembly includes a latch and said frame defines a second opening into said cavity, said latch being operatively accepted into said second opening upon insertion of said tab into said cavity, thereby helping to maintain said temple piece operatively with said frame.

16. Eyewear comprising:
a frame having at least one temple end, said frame defining at least one aperture and one cavity therein, and said temple end defining an opening into one of said cavities;
at least one lens module, said lens module having a front portion and rear portion, a lens element, a flange with a front and a back, and a projection, whereby said lens module may be operatively inserted into said aperture of said frame and extend therethrough such that said front of said flange operatively contacts a portion of said frame about said aperture; and
a temple piece having a frame end, said frame end terminating in a tab assembly having a tab, said tab being operatively acceptable into one of said cavities in said frame, through said opening in said temple end, for operatively attaching said temple piece to said frame.

17. The eyewear of claim 16 wherein said lens module includes a channel formed therein for accepting a portion of said frame therein to help maintain said lens module in said aperture.

18. The eyewear of claim 17 wherein said projection of said lens module includes at least one tab formed thereon and said channel is formed between said tab and said flange.

19. The eyewear of claim 16 further comprising a padding member removably attachable to said rear portion of said frame.

20. The eyewear of claim 16 wherein said tab assembly articulates relative to said temple piece.

21. The eyewear of claim 16 wherein said tab assembly includes a latch and said frame defines a second opening into said cavity, said latch being operatively accepted into said second opening upon insertion of said tab into said cavity, thereby helping to maintain said temple piece operatively with said frame.

22. The eyewear of claim 17 further comprising a padding member removably attachable to said rear portion of said frame, wherein said tab assembly articulates relative to said temple piece and said tab assembly includes a latch and said frame defines a second opening into said cavity, said latch being operatively accepted into said second opening upon insertion of said tab into said cavity, thereby helping to maintain said temple piece operatively with said frame.
